(19) United States
(12) Patent Application Publication
(10) Pub. No.: US 2005/0153036 A1
(43) Pub. Date: Jul. 14, 2005

(54) Dual-use container and methods of reusing same

(75) Inventors: James Keenan Grelle, Clayton, MO (US); Christopher James Nahm, Rock Hill, MO (US)

Correspondence Address: Dean D. Small;Armstrong Teasdale LLP, Suite 2600, One Metropolitan Square, St. Louis, MO, 63102, US

(73) Assignee: TRG Accessories, L.L.C.

(21) Appl. No.: 11/068,279

(22) Filed: Feb. 28, 2005

Related U.S. Application Data
(63) Continuation-in-part of application No. 10/799,084, filed on Mar. 12, 2004.
(60) Provisional application No. 60/535,728, filed on Jan. 9, 2004.

(51) Int. Cl. A23B 4/00

(52) U.S. Cl. 426/396

(57) ABSTRACT

A dual-use product package includes a non-food product and a non-rigid base defining a cavity holding the non-food product at a point of purchase display. The base is adapted for use apart from the non-food product once the non-food product is removed from the cavity. A cover is configured to close the cavity, and at least a portion of the cover is transparent. A carrying handle is secured to one of the cover and the base. Methods of reusing the dual use container include packing a non-food item in the cavity, presenting the dual-use container in combination with the non-food item packed therein at a point of purchase, and configuring the dual use container to be reusable as at least one of a backpack, a purse, and a briefcase.

### CROSS REFERENCE TO RELATED APPLICATIONS

This application is a continuation-in-part application of U.S. application Ser. No. 10/799,084, which claims the benefit of U.S. Provisional Application Ser. No. 60/535,728 filed Jan. 9, 2004, the complete disclosures of which are each hereby incorporated by reference in their entirety.

### BACKGROUND OF THE INVENTION

This invention relates generally to product packaging, and, more particularly, to product packaging having independent use apart from packaging the product.

Often, product packaging serves little purpose to a consumer after the product is removed from the packaging. Product packaging, therefore, is ordinarily discarded by consumers. Accordingly, a great deal of waste is attributable to product packaging. Some product packaging, such as, for example, shoe boxes, may be used for other purposes after footwear has been removed from the boxes, although at least a significant portion of shoe boxes are immediately discarded by consumers.

Conventionally, footwear has been packaged in cardboard shoe boxes, and the shoe boxes include a rectangular base for holding footwear and a removable lid having downwardly depending sides which are received over the side walls of the base. The cardboard is relatively rigid, which allows multiple boxes to be stacked upon one another in a store or retail outlet display shelf or storage area. The lid is not fastened to the base but simply rests upon it so that the footwear may be readily accessed for inspection or a trial fit with a prospective purchaser.

Because of their sturdy construction, shoe boxes have sometimes been used as stackable storage boxes and organizers for papers and a host of other items by children and adults. Cardboard shoe boxes, however, were not designed for this type of use, and if they are handled regularly, they easily wear out. Also, because the lid of a shoe box is not fastened or otherwise secured to the base, contents in the box may be inadvertently exposed or spilled from the box as it is handled. While the lid may be taped to the sides of the base to avoid this problem, applying tape to the lid can be inconvenient, and removal of the tape tends to tear the sides of the base and/or the lid, thereby accelerating its demise. Furthermore, conventional shoe boxes typically lack a carrying handle and are therefore inconvenient to transport from place to place.

On another note, innovative product packaging often positively affects the desirability of a product to consumers. Footwear, for example, has been sold in cardboard boxes for such a long time that it is believed that the public has grown weary of them. For footwear manufacturers, conventional shoe packaging in cardboard boxes presents little opportunity to distinguish their products from other manufacturers.

It would be desirable to provide alternative product packaging which avoids these and other disadvantages for products such as footwear.

### BRIEF DESCRIPTION OF THE INVENTION

According to an exemplary embodiment, a dual-use product package is provided. The package comprises a non-food product and a non-rigid base defining a cavity holding the non-food product at a point of purchase display. The non-rigid base is adapted for use apart from the non-food product once the non-food product is removed from the cavity. A cover is configured to close the cavity, and at least a portion of the cover is transparent. A carrying handle is secured to one of the cover and the base and extends outwardly therefrom.

Optionally, a closure member may be provided to secure the cover to the base. The closure member may comprise a zipper mechanism which is spaced from a bottom surface of the base and spaced from the cover. A pair of handles may be provided with the closure member positioned between the pair of handles. The cover may comprise a front panel and a foldover flap, and the package may include a closure member located on the foldover flap. The non-food product may constitute footwear held in the cavity, a shoulder strap may be provided for carrying the package.

According to another exemplary embodiment, a footwear package comprises a support surface, and a plurality of soft side walls extending from the support surface and defining a cavity for holding footwear above the support surface. A cover is coupled to the base and secured thereto with a closure member extending on at least one the soft side walls. The cover is at least partially transparent for visual inspection of the cavity without opening the cover.

In another exemplary embodiments, a method of reusing a footwear package comprises packaging footwear in a soft sided package having the form of at least one of a backpack, a purse, and a brief case.

In still another exemplary embodiment, a method for selling a non-food item in combination with a dual-use container is provided. The method comprises providing a dual-use container having a storage cavity, packing a non-food item in the cavity, closing the cavity with a cover, presenting the dual-use container in combination with the non-food item packed therein at a point of purchase, and configuring the dual use container to be reusable such that a purchaser of the dual use container in combination with the non-food item is able to remove the non-food item without damaging or destroying the dual-use container and repack the dual-use container for use as at least one of a backpack, a purse, and a brief case.

According to still another exemplary embodiment, a footwear package is provided which comprises a support surface, and a plurality of soft side walls extending from the support surface and defining a cavity for holding footwear above the support surface. A cover is coupled to the base and secured thereto with a closure member, and at least one shoulder strap coupled to one of the support surface, the side walls, and the cover.

### BRIEF DESCRIPTION OF THE DRAWINGS

FIG. 1 is a perspective view of a footwear package according to an exemplary embodiment of the invention.

FIG. 2 is a perspective view of the footwear package shown in FIG. 1 opened and ready for use.

FIG. 3 is a top plan view of the package shown in FIG. 2 packed with footwear.

FIG. 4 is a top plan view of the package shown in FIGS. 1 and 2 packed with lunch items.

FIG. 5 is a side view of another embodiment of a footwear package in accordance with an exemplary embodiment of the invention.

FIG. 6 is a perspective view of another exemplary embodiment of a dual-use product package in accordance with the present invention.

FIG. 7 is a perspective view of another exemplary embodiment of a dual-use product package in accordance with the present invention.

FIG. 8 is a perspective view of another exemplary embodiment of a dual-use product package in accordance with the present invention.

### DETAILED DESCRIPTION OF THE INVENTION

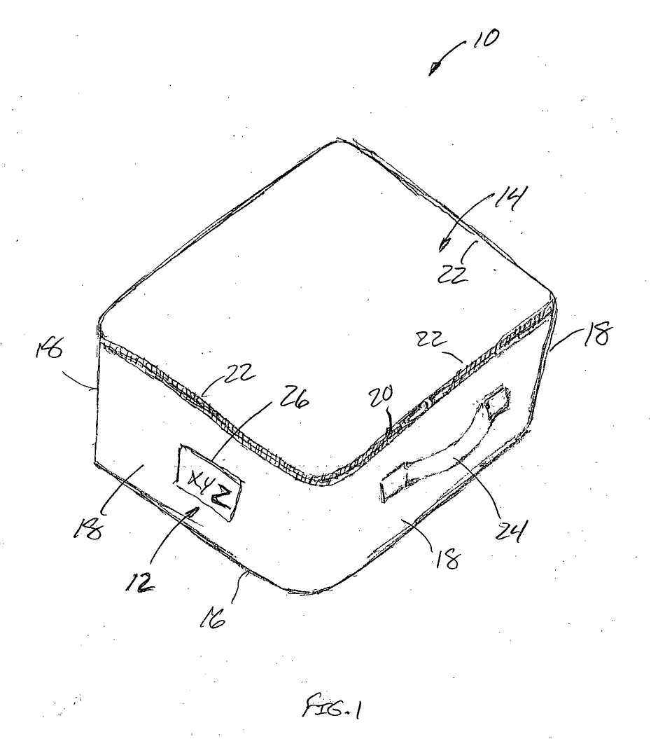

FIG. 1 is a perspective view of a dual-use product package 10 according to an exemplary embodiment of the invention which may be used to package a non-food product and a food product for transportation and storage therein. As used herein, the terms “food product” or “food item” refer not only to edible food and beverage items, but also complementary items commonly used in conjunction therewith when eating such food and beverage items, including but not limited to beverage holders (e.g., a thermos container, glass, cup or can) and eating utensils, plates and flatware, napkins, salt and pepper shakers, condiments, food warmers, cooling blocks or ice-packs, etc used to prepare, preserve, and aid in the consumption and presentation of edible foods. The food products also include prepackaged food such as LUNCHABLES® packaged meal combinations of Kraft Foods Holdings, Inc., prepackaged juice products, sippy cups, baby bottles and the like.

The terms “non-food product” or “food item” as used herein includes any and all items which are not food products or food items, including but not limited to footwear, books, magazines and periodicals, clothing related items (e.g., shirts, gloves, socks, hats and stocking caps), toy related items (e.g., toys, dolls, cars, action figures, crayons and coloring books), game-related items (e.g., cards, board games, video games, and game accessories), sports-related items (e.g., balls, gloves, caps, posters and trading cards), entertainment-related items (e.g., music, compact discs, cassettes, dvd's, movies, and multimedia products), and infant care-related items (e.g., diapers, formulas, lotion and the like).

As will be explained below, the package 10, in addition to capably packaging non-food products for point of purchase displays and sale, the package 10 is designed for other purposes than non-food product storage or transportation. As such, the package 10 is believed to be desirable to consumers apart from the associated product and presents distinctive packaging options that may present a welcome change to weary consumers in product areas typically presented for sale in traditional paper or cardboard packaging.

While in one embodiment, the package 10 is well suited for packaging of a non-food product, as described below, the description hereinbelow is set forth as only one example of potential product packaging which may benefit from the inventive concepts described below. The description herein is therefore set forth for illustrative purposes only, and the invention is not intended to be restricted to any particular type of non-food product, such as footwear products.

In an exemplary embodiment, the package 10 includes a base 12 and a cover 14 secured to the base. The base 12 includes a bottom support surface 16 and four side walls 18 which collectively define a cavity (not shown in FIG. 1) in which a non-food product (e.g., footwear) may be contained at, for example, a point of purchase display. The cover 14 is secured to the base 12 with a known closure member, such as a zipper mechanism 20, which extends along upper edges of three of the side walls 18 and corresponding side edges 22 of the cover 14. A carrying handle 24 is affixed to one of the base side walls 18 for convenient transport of the package 10.

In an exemplary embodiment, the base 12 and the cover 14 are fabricated from nylon, canvas, cloth, or other suitable material to form a non-rigid or soft sided, yet structurally sufficient package relative to comparatively rigid cardboard and paper materials conventionally used in non-food product packaging, and especially in comparison to known plastic and metallic materials conventionally used in hard-shell case construction. By employing nylon, canvas, cloth, or another non-rigid material to fabricate a soft shell package 10, a lightweight yet very durable package may be provided in a comparatively low cost construction. Additionally, a user friendly zipper mechanism 20 is well suited for a soft sided construction of the package 10. Bulky and difficult to use mechanical closure elements to securely close the cover 14 may therefore be avoided. Alternatively, other known closure members may be employed, including but not limited to Velcro fasteners, snaps, drawstrings, and other closure systems appreciated by those in the art. The package 10 may be liquid impermeable in one embodiment, and the cover 14 may be joined to the base 12 in a liquid impermeable manner to form a seal therebetween.

Stiffening elements (not shown), such as wire frame elements and the like, may be provided to maintain a desired shape of the cover 14, the base support surface 16, and/or the side walls 18 as desired or as necessary for added strength and rigidity of the package 10. Graphics and multiple colors may be employed on any of the outer surfaces of the package 10, and the shape of the package 10 may be varied to create distinctly different visual appearances of the package 10.

In an exemplary embodiment, the carrying handle 24 is fabricated from a nylon, canvas or other pliable material and is stitched to one of the side walls 24 of the base 12. Metallic fastening elements, such as screws, are therefore avoided along with their associated expense and assembly challenges. Like the rest of the package, the handle 24 may include stiffening frame elements to ensure a particular shape of the handle 24, graphics and colors may be employed in the handle 24, and the handle may be fabricated into a variety of shapes in various embodiments to change the visual appearance of the package 10. While the illustrated embodiment of the package 10 includes one handle 24, more than one handle 24 be could provided for transport in more than one orientation when gripped by a user. Alternatively, the handle 24 may be moved to another location on the package 10 for another mode of transport when gripped by a user.

In an exemplary embodiment, the package includes indicia 26 which in various embodiments may be indicia identifying a source of a non-food item, which may be the same as the non-food item sold in the package 10. Alternatively, the indicia 26 could indicate the source of a food item which may be stored or transported in the package 10 at a later time. The indicia 26 may include brand names, business names, trademarks, logos or other indicia to promote particular products or services. Additionally, the indicia 26 may be unrelated to either the non-food item sold in the package 10 or food-items which may be used therewith, but the indicia may identify, for example, a sports team, a cartoon character, an entertainment event, an entertainment figure or a movie. Thus, package themes and promotion of related and unrelated items and services may be graphically promoted on one or more of the outer surfaces of the package 10, including the top and bottom surfaces, and the side surfaces which connect the top and the bottom. Graphics and indicia may be transferred printed, or otherwise applied to the package in a known manner.

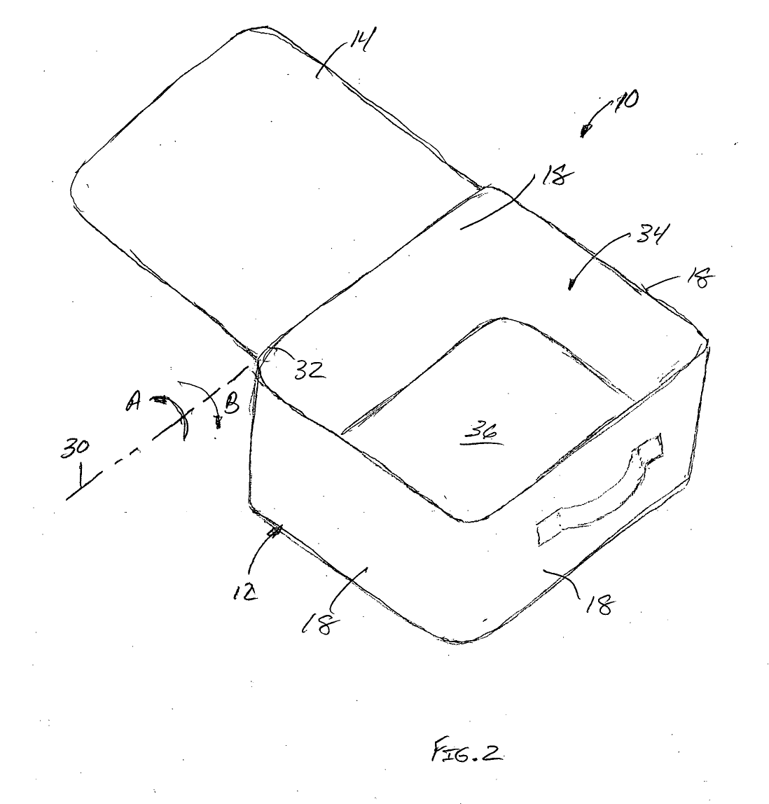

FIG. 2 is a perspective view of the package 10 with the zipper mechanism 20 (shown in FIG. 1) actuated to uncouple the cover 14 from three side walls 18 of the base 12. The cover 14 is hingedly attached to the remaining side wall (i.e., the fourth side wall 18 of the base 12) along a top edge 32 thereof. The cover 14 is rotated about an axis 30 coincident with the top edge 32 in a direction of arrow A to an opened position wherein the cavity 34 of the base 12 is exposed for packaging of a product (not shown in FIG. 2) above the bottom support surface 36 of the base 12.

In an exemplary embodiment, the cover 14 is integrally formed with the rear side wall 18 along the top edge 32, and the cover 14 is folded over the top edge 32 to the closed position shown in FIG. 1. The integral folding construction of the cover 14 with one of the side walls 18 is a further benefit of the soft shell or soft sided construction of the package 10. Mechanical fasteners, hinge elements and/or or pivotal mounts are avoided, together with their associated cost, while nonetheless reliably securing the cover 14 to the base 12 and while achieving a hinge action of the cover 14 relative to the base 10. Additionally, as the cover 14 is permanently attached to the base 12 in this construction, the cover 14 may not be inadvertently separated from the base 12, or possibly even lost, when the package 10 is in use.

The cover 14 is therefore fixedly attached to the base 12 along the top edge 32, while the remaining side walls may be secured to the cover 14 with the zipper mechanism 20 (shown in FIG. 1) when the cover 14 is rotated about the axis 30 in the direction of arrow B back to the closed position shown in FIG. 1. The cover 14 may therefore be effectively secured to the base 12 along each of the side walls of the base 12 to securely enclose the cavity 34 when a non-food product, such as footwear, is placed therein. Inadvertent exposure or spillage of the product from the base 12 is therefore avoided.

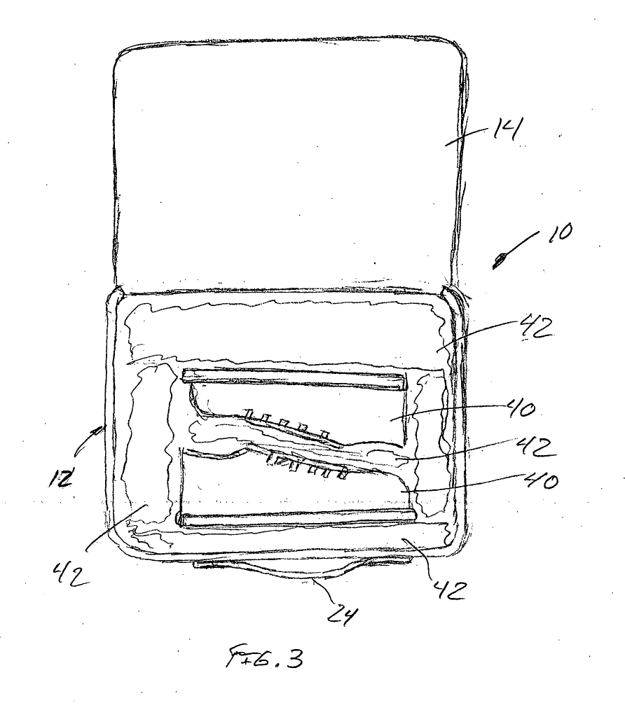

FIG. 3 is a top plan view of the package 10 packed with a non-food product such as footwear 40. In an exemplary embodiment, the footwear 40 is a pair of tennis shoes, although it is appreciated that any type of shoe or footwear for children or adults, or also a non-footwear product, could be employed in another embodiment of the invention. Packing material 42, such as known packing paper 42, is provided around the footwear 40 to protect the footwear 40 and prevent movement of the footwear 40 relative to the base 12 when the package 10 is closed as shown in FIG. 1 and carried with the carrying handle 24. Additionally, the packing material 42 facilitates stacking of multiple packages 10 upon one another in for example, a point of purchase display. Other types of packing material familiar to those in the art may be used in lieu of paper packing material in alternative embodiments of the invention.

It is contemplated that the package 10 could be sold in combination with other items. For example, a toy-related item (e.g., an action figure or doll) could be sold with the toy outside the package 10, while other toy-related items (e.g., action figure or doll accessories) may be packed in the package 10. Thus, the action figure could be prominently featured in a point of purchase display in a separate container which includes the package 10. In such an embodiment, when not in use with the toy-related items, the package 10 could be used as a lunchbox. As another example, the package 10 could be packed with a non-food item (e.g., footwear) and sold with an unrelated item (e.g., a toy) wherein the toy is a prominent feature of the point of purchase presentation and the package 10 is a secondary or ancillary feature of the packaged combination.

For the reasons described above, the package 10 therefore provides a distinctive appearance and a convenient carrying case for a non-food product such as the footwear 40 in a lightweight, durable, and secure construction. An added benefit of this lightweight, durable and secure construction, however, is that the package 10 may capably serve for stowing or transporting other items, such as food products once the product (e.g. footwear) 40 is unpacked from the package 10.

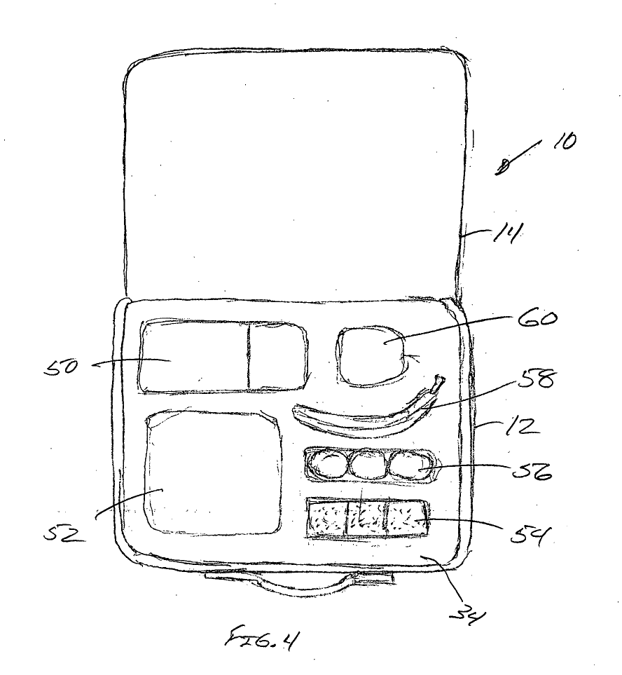

By way of example, FIG. 4 is a top plan view of the package 10 loaded with food product, and more specifically lunch items. In an illustrative embodiment, and as shown in FIG. 4, the lunch items includes as a thermos 50, a wrapped sandwich, a pack of crackers 54, a pack of cookies 56, a banana 58 and an apple 60. It is understood that the lunch items could alternatively include a variety of edible food products, beverage and snack items customary to dietary and eating habits of a particular consumer, as well as condiments, napkins, utensils etc. which ordinarily accompany a prepared lunch meal or snack. The lunch items may be secured in the package 10 with little risk of exposure or spillage of the lunch items from the package, and the zipper mechanism 20 provides easy access to the cavity 34 for packing and unpacking of lunch items.

The base 12 and the cover 14, in one embodiment, are fabricated from known insulative materials, or other wise include insulative padding or features, which permit the base 12 and cover 14 to function as a cooler when loaded with food or beverage items. Thus, a meal or snack may be maintained in a hot or cold condition for some period of time for convenience by the user.

Thus, in the foregoing exemplary embodiment, the package 10 may capably serve as a lunchbox for convenient use of footwear purchasers after the footwear is removed therefrom. The zipper mechanism 20 and the soft sided construction of the package 10 make a user friendly package 10 for food products forming school lunches, work lunches, picnics, etc. and when appropriate colors and graphics are included on the package 10, the package 10 may serve as a distinctive and attractive lunchbox for children and adults alike.

Appropriate modifications, such as dividers, tie down straps, etc, may be provided-in the cavity 34 of the lunchbox 10 to make the package 10 more amenable for use as a lunchbox. Additionally, identification tags and other accessories may be provided in further and/or alternative embodiments of the invention, and such modifications and accessories may be sold at the point of purchase of the non-food product (e.g., footwear), either separately or together with the footwear package 10.

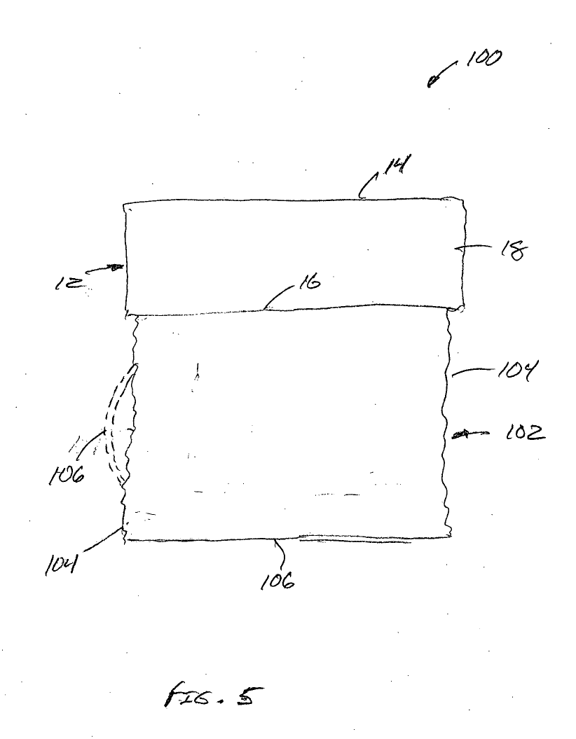

FIG. 5 is a side view of another embodiment of a product package 100 in accordance with an exemplary embodiment of the invention. Similar to the package 10 (shown in FIGS. 1-4), the package 100 includes a base 12 having a bottom support surface 16 and side walls 18 which define a cavity (not shown in FIG. 5) in which a non-food product, including but not limited to footwear, may be accommodated.

An expandable section 102 is integrated into the bottom support surface 16 of the base 12 and includes side walls 104 which are secured to the bottom surface 16 at one end thereof and a bottom wall 106 connecting the side walls 104. The expandable section 102 may be fabricated from nylon, canvas, cloth, or other suitable material familiar to those in the art. A handle element 106 (shown in phantom in FIG. 5) may be provided on the expandable section 106 to provide a carrying position when the expandable section 102 is expanded from the bottom wall. When not in use, the expandable section may be folded, arranged, or otherwise tucked into the bottom supporting surface 16 of the base 12 in a known manner. When not expanded, the expandable section 102 is substantially transparent, or not visible, to the casual observer and the package 100 looks substantially similar to the package 10 as illustrated in FIGS. 1 and 2.

Access to the expandable section may be provided through the bottom support surface 16 of the base, the side walls 104 or the bottom wall 106 in a known manner such as, for example, with a zipper mechanism, Velcro straps and the like as those in the art may appreciate. The expandable section 102 defines an enlarged cavity between the side walls 104 and the bottom wall 106 for stowage and transport of additional items. For example, in one contemplated embodiment, the expandable section 102 is extendible from the base 12 to convert the base 12 into a duffel bag.

In a duffel bag configuration, the expandable section 102 may accommodate a work-out suit, a towel and small toiletries to be stowed and transported by a user, in addition to a food-product or a non-food product as explained above As such, aside from product packaging, the package 100 may be used as a lunchbox on certain days and as a workout bag on other days, or a combination lunchbox/duffel bag. For example, footwear originally contained in the package 100, and/or other non-food items may be packed into the expandable section 102 and food-items packed in the base 12 of the package 100 as described above. As another example, the expandable section 102 may include a swimsuit, a towel, suntan lotion, etc., and the base 12 may be used as a lunchbox for a pleasurable afternoon excursion to the beach or to the pool.

In a further embodiment, the expandable section 102 may be fabricated from an insulative material or materials and serve as an expanded capacity cooler for hiking, camping, boating, or other outdoor activities.

In still other embodiments, the expandable section 102 may be configured as a shopping bag which may include other purchase items in a retail environment. Thus, for example, if a consumer wishes to purchase a pair of shoes and a shirt, the shirt could be placed in the expandable section 102 during checkout and the consumer could exit the store with the package 100 including both the shoes and the shirt. Graphics may be printed or otherwise placed on the packaging with names, logos, trademarks or other indicia of interest for either the product purchased or the retailer from whom it was purchased.

While several example configurations have been discussed for the expandable section 102, it is noted that these are intended only as examples. Other configurations are possible which are encompassed by the scope and spirit of the present invention.

Distinctive dual-use product packages 10 and 100 are therefore provided in a lightweight, totable form. After the non-food product (e.g., footwear) is unpacked, the durable package 10 or 100 is suitable for everyday use, such as a lunchbox for storing and transporting food products, a duffel bag for carrying other items in addition to food products, or other purposes which complement the non-food product sold in the package. For example, golf shoes could be sold in the package 100 wherein the expandable section is configured to hold golf balls, tees, scorecards, etc. Hiking boots could be sold in a package with an expandable section configured to hold hiking gear. Baseball cleats could be sold in such packages with the expandable section configured to hold a baseball glove, a batting glove and a baseball. Such complementary products could be sold together with the applicable footwear product, or purchased separately by consumers as desired. Countless other products may be sold in such packages 10 or 100 with a variety of products, including but not limited to footwear products.

Waste is therefore avoided with innovative product packaging which may be desirably used for other purposes use once the product is unpacked, such as in the lunchbox example. The foregoing product packages may further complement the use and enjoyability of the product by stowing and toting the product along with other complementary items needed for an activity which entails use of the product, such as the foregoing footwear examples.

Optionally, the base 12 and/or cover 14 may be constructed of a rigid material (e.g., metal or plastic) and the cover 14 may be entirely removable from the base 12. Moreover, the cover 14 may be secured to the base 12 by a fastener other than a zipper, including but not limited to Velcro fasteners, snap-on sealed interfaces, snaps, and the like. The cover 14 may be attached to the base 12 at one point via, for example, a nylon or plastic strap, or a mechanical hinge, such as a metal hinge element.

The packages 10 and 100 lend themselves to innovative branding, selling and promotion for wide variety of products and services for mass appeal to different groups of consumers. Am exemplary method for selling a non-food item in combination with a dual-use container includes providing a dual-use container (e.g., the containers 10 or 100 described above) having a storage cavity configured to hold separately a non-food item and a food item one at a time. A non-food item (e.g., clothing, footwear, a toy-related item, a sports-related item, a book, a magazine, a game-related item, an entertainment-related item, or an infant care-related item) is packed in the cavity, for example, by closing the aforementioned zipper connecting the cover and a base of the dual-use container, and the dual-use container is presented in combination with the non-food item packed therein at a point of purchase. For the reasons explained above, the dual-use container is configured to be reusable such that a purchaser of the dual use container in combination with the non-food item is able to remove the non-food item without damaging or destroying the dual-use container and repack the dual-use container with a food item. The food-item may constitute an edible food item, a beverage, a beverage holder, utensils, plates, flatware, napkins, condiments, a food warmer, a cooling block, etc.

By providing indicia on the dual use container, commercial sources of a non-food item and/or a food item may be indicated. Additionally, indicia provided on the dual use container may identify, for example a sports team, a cartoon character, entertainment event, entertainment figure or a movie, wherein said branding indicia is not indicative of a source of the non-food item.

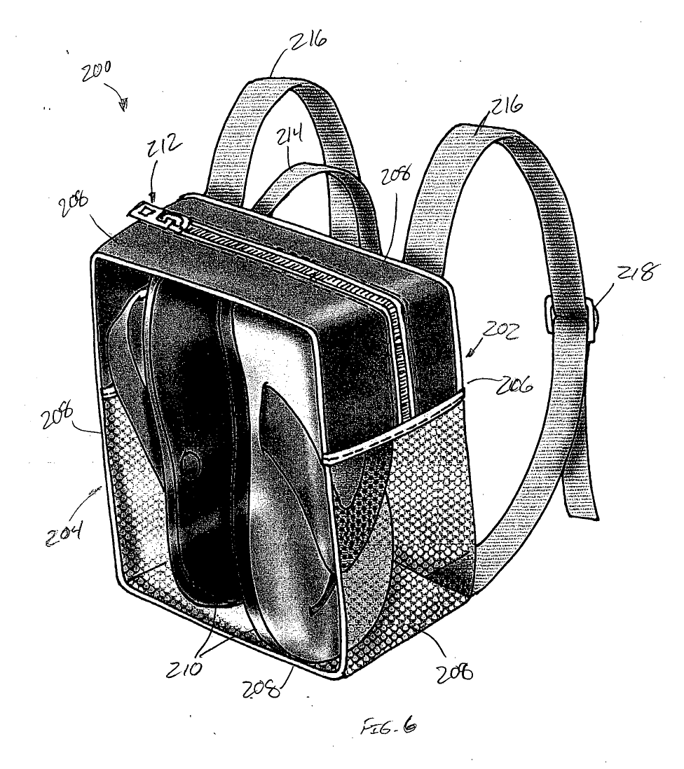

FIG. 6 illustrates another exemplary embodiment of a dual-use container in the form of a product package 200. Like the foregoing packages, the package 200, in addition to capably packaging non-food products for point of purchase displays and sale, the package 200 is designed for other purposes. As such, the package 200 is believed to be desirable to consumers apart from the associated product and presents distinctive packaging options that may present a welcome change to weary consumers in product areas typically presented for sale in traditional paper or cardboard packaging.

As illustrated in FIG. 6, the package 200 includes a base 202 and a cover 204 secured to the base. The base 202 includes a bottom support surface 206 and four side walls 208 which collectively define a cavity in which a non-food product (e.g., footwear 210) may be contained at, for example, a point of purchase display. The cover 204 is secured to the base 202 opposite the bottom support surface 206 and overlies the side walls 208. A known closure member, such as a zipper mechanism 212, provides access to the cavity for insertion and removal of products. The zipper mechanism 212 extends along a portion of two of the side walls 208 and completely across one of the adjoining side walls 208. The zipper mechanism 212 is located in a substantially centered position on the associated side walls 208 and is distanced from each of the bottom support surface 206 and the cover 204. A carrying handle 214 is affixed to the bottom support surface 206 for convenient transport of the package 200 at an upper edge thereof, and carrying straps 216 are also provided. The straps 216 form loops which may be used as shoulder straps if desired. Thus, the package 200 may serve not only as a product package at a point of sale, but also as a reusable backpack to transport food products or non-food products (e.g., the footwear 210 or other non-food products).

Like the foregoing packages, the base 202 and the cover 204 are fabricated from nylon, canvas, cloth, or other suitable materials to form a non-rigid or soft sided, yet structurally sufficient package relative to comparatively rigid cardboard and paper materials conventionally used in non-food product packaging (e.g., footwear packaging), and especially in comparison to known plastic and metallic materials conventionally used in hard-shell case construction. By employing nylon, canvas, cloth, or another non-rigid material to fabricate a soft shell package 200, a lightweight yet very durable package may be provided in a comparatively low cost construction.

As illustrated in FIG. 6, a variety of materials may be employed to fabricated the package 200 to provide a distinctive appearance and to customize the package 200 for certain activities. For example, considering the example of FIG. 6, portions of the side walls 208 may be fabricated from a transparent or see-through mesh material while other portions of the side walls 208 are fabricated from a substantially opaque material. Furthermore, the cover 204 is fabricated from a substantially transparent material to provide a light and airy package 200. The package 200 is therefore well suited for an afternoon or day trip to the pool or beach, and the footwear 210 sold in the package 200 is accordingly thong sandals. Once the sandals are removed, the package 200 may be packed with for example, non-food products such as a towel, suntan lotion, a book, and/or food products such as edible items, beverage items, and associated items which may enjoyed at poolside or on the beach. Such items could be sold together with the footwear 210 or acquired separately by the consumer.

A user friendly zipper mechanism 212 is provided for ready access to the contents of the package 200 while avoiding bulky and difficult to use mechanical closure elements. It is understood, however, that the package may be otherwise adapted in various alternative embodiments, including the use of various known materials to fabricate the package, the use of other known closure members (e.g., Velcro fasteners, snaps, drawstrings, and other closure systems), the use of sealing elements to provide a sealed package, the use of insulated walls to allow the use of the package as a cooler, etc.

As with the foregoing packages, stiffening elements (not shown in FIG. 6), such as wire frame elements and the like, may be provided in the package 200 to maintain a desired shape of the cover 204, the base support surface 206, and/or the side walls 208 as desired or as necessary for added strength and rigidity of the package 200. Graphics and multiple colors may be employed on any of the outer surfaces of the package 200, and the shape of the package 200 may be varied to create distinctly different visual appearances of the package 200.

In an exemplary embodiment, the carrying handle 214 and the carrying straps 216 are fabricated from a nylon, canvas or other pliable material and are attached, for example, to the bottom support surface 206 according to a known method such as stitching. Known adjustment elements 218 are provided on the respective straps 216 to adjust the size of the loops which the straps 216 define, and therefore the straps 216 may be adjusted to accommodated a wide range of users. Like the rest of the package, the handle 214 and/or the carrying straps 216 may include stiffening frame elements to ensure a particular shape of the handle 214 and the straps 216, and graphics and colors may be employed in the handle 214 and the straps 216. The handle 214 and the straps 216 may be fabricated into a variety of shapes in various embodiments to change the visual appearance of the package 200.

As described above, the package 200 may include indicia identifying a source of a non-food item, which may be the same as the non-food item sold in the package 200. Alternatively, such indicia could indicate the source of a food item which may be stored or transported in the package 200 at a later time. Indicia may include brand names, business names, trademarks, logos or other indicia to promote particular products or services, whether related or unrelated to either the non-food item sold in the package 200 or food-items which may be used therewith, including but not limited to indicia signifying a sports team, a cartoon character, an entertainment event, an entertainment figure or a movie. Thus, package themes and promotion of related and unrelated items and services may be graphically promoted on one or more of the outer surfaces of the package 200, including the top and bottom surfaces, and the side surfaces which connect the top and the bottom. Graphics and indicia may be transferred printed, or otherwise applied to the package in a known manner.

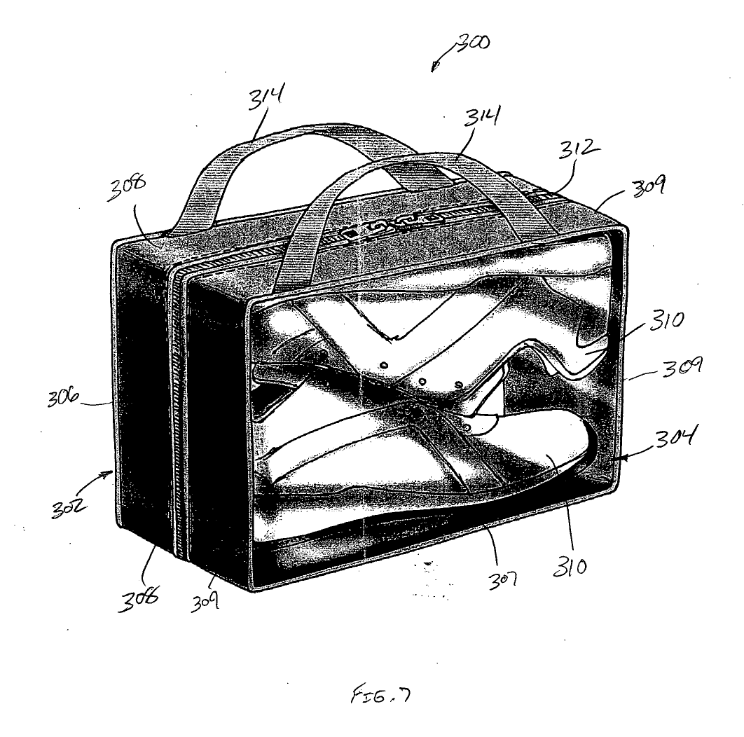

FIG. 7 illustrates another exemplary embodiment of a dual-use container in the form of a package 300 which in addition to capably packaging non-food products for point of purchase displays and sale, is designed for other purposes. The package 300 is believed to be desirable to consumers apart from the associated product and presents distinctive packaging options that may present a welcome change to weary consumers in product areas typically presented for sale in traditional paper or cardboard packaging.

As illustrated in FIG. 7, the package 300 includes a base 302 and a cover 304 secured to the base. The base 302 includes a bottom support surface 306 and four side walls 308. The cover 304 includes a front panel 307 and side walls 309 extending from the front panel 307. The side walls 308 of the base 302 and the side walls 309 of the cover 304 collectively define a cavity in which a non-food product (e.g., footwear 310) may be contained at, for example, a point of purchase display. The cover 304 is secured to the base 302 with a known closure member, such as a zipper mechanism 312, which joins the cover side walls 309 with the base side walls 308. The zipper mechanism 312 is located in a substantially centered position between the bottom support surface 306 of the base 302 and the front panel 307 of the cover 304.

A pair of carrying handles 314 provided such that one of the handles 314 is affixed to one of the side walls 308 of the base 302 and one of the handles is affixed to one of the side walls 309 of the cover 304. Additionally, one of the handles 314 is located adjacent the front panel 307 of the cover 304 while the other handle 314 is located adjacent the bottom support surface 306 of the base 302. The zipper mechanism 312 extending between the pair of handles 314. The handles 314 are generally aligned with one another and may be gripped with a single hand for convenient transport of the package 300. The package 300 may serve not only as a product package at a point of sale, but also a reusable tote bag or purse to transport non-food items (e.g., the footwear 310) after purchase, together or separate from other items of interest, whether food items or non-food items.

Like the foregoing packages, the base 302 and the cover 304 are fabricated from nylon, canvas, cloth, or other suitable materials to form a non-rigid or soft sided, yet structurally sufficient package relative to comparatively rigid cardboard and paper materials conventionally used in non-food product packaging (e.g., footwear packaging), and especially in comparison to known plastic and metallic materials conventionally used in hard-shell case construction. By employing nylon, canvas, cloth, or another non-rigid material to fabricate a soft shell package 300, a lightweight yet very durable package may be provided in a comparatively low cost construction.

A variety of materials may be employed to fabricated the package 300 to provide a distinctive appearance and to customize the package 300 for certain activities. For example, considering the example of FIG. 7, the front panel 307 of the cover 304 is fabricated from a substantially transparent material which permits ready visual inspection of the contents of the package 300 without opening the package 300, while the remainder of the package 300 is fabricated from opaque materials. As one illustrative example, the package 300 is well suited as packaging for girls footwear 310, and the package 300 may be reused, for example, as a purse or makeup bag. That is, once the footwear 310 is removed, the package 300 may be packed with, for example, makeup items, hairbrushes, and accessories. Such items could be sold together with the non-food product (e.g., the footwear 310) in the package 300 or acquired separately by the consumer.

A user friendly zipper mechanism 312 is provided for ready access to the contents of the package 300 while avoiding bulky and difficult to use mechanical closure elements. It is understood, however, that the package may be otherwise adapted in various alternative embodiments, including the use of various known materials to fabricate the package, the use of other known closure members (e.g., Velcro fasteners, snaps, drawstrings, and other closure systems), the use of sealing elements to provide a sealed package, the use of insulated walls to allow the use of the package as a cooler, etc.

As with the foregoing packages, stiffening elements (not shown in FIG. 7), such as wire frame elements and the like, may be provided in the package 300 to maintain a desired shape of the cover 304, the base support surface 306, and/or the side walls 308 as desired or as necessary for added strength and rigidity of the package 300. Graphics and multiple colors may be employed on any of the outer surfaces of the package 300, and the shape of the package 300 may be varied to create distinctly different visual appearances of the package 300.

In an exemplary embodiment, the carrying handles 314 are fabricated from a nylon, canvas or other pliable material and are attached, for example, to the bottom support surface 306 according to a known method such as stitching. Like the rest of the package, the handle 314 may include stiffening frame elements to ensure a particular shape of the handles 314, and graphics and colors may be employed in the handles 314. The handles 314 may be fabricated into a variety of shapes in various embodiments to change the visual appearance of the package 300.

As described above, the package 300 may include indicia identifying a source of a non-food item, which may be the same as the non-food item sold in the package 300. Alternatively, such indicia could indicate the source of a food item which may be stored or transported in the package 300 at a later time. Indicia may include brand names, business names, trademarks, logos or other indicia to promote particular products or services, whether related or unrelated to either the non-food item sold in the package 300 or food-items which may be used therewith, including but not limited to indicia signifying a sports team, a cartoon character, an entertainment event, an entertainment figure or a movie. Thus, package themes and promotion of related and unrelated items and services may be graphically promoted on one or more of the outer surfaces of the package 300, including the top and bottom surfaces, and the side surfaces which connect the top and the bottom. Graphics and indicia may be transferred printed, or otherwise applied to the package in a known manner.

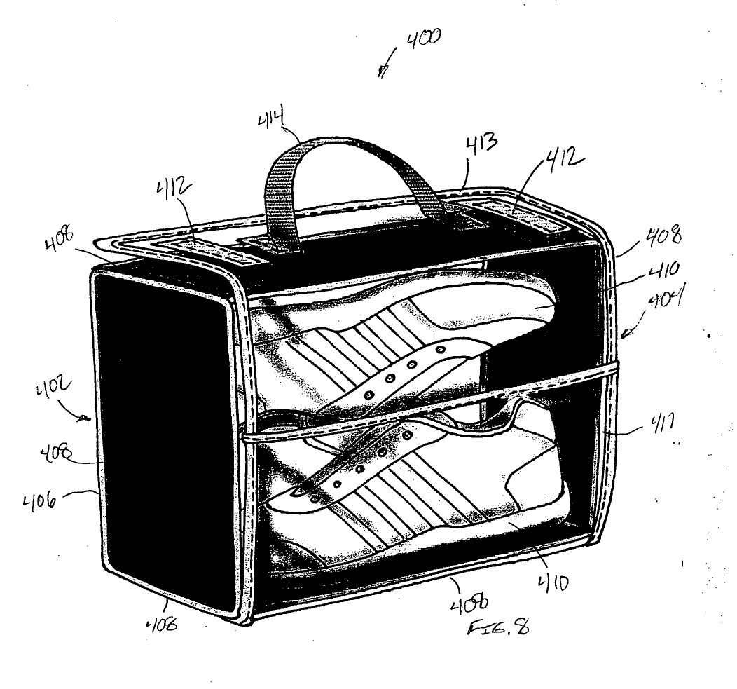

FIG. 8 illustrates another exemplary embodiment of a dual-use container in the form of a package 400 which in addition to capably packaging non-food products for point of purchase displays and sale, is designed for other purposes. The package 400 is believed to be desirable to consumers apart from the associated product and presents distinctive packaging options that may present a welcome change to weary consumers in product areas typically presented for sale in traditional paper or cardboard packaging.

As illustrated in FIG. 8, the package 400 includes a base 402 and a cover 404 secured to the base. The base 402 includes a bottom support surface 406 and four side walls 408 which collectively define a cavity in which a non-food product (e.g., footwear 410) may be contained at, for example, a point of purchase display. The cover 404 is secured to the base 402 with a known closure member, such as a pair of Velcro strips 412. The Velcro strips 412 are located on a foldover flap 413 of the cover 402 which extends substantially perpendicular to a front panel 411 of the cover 402. The front panel portion 411 extends substantially parallel to the bottom support surface 406 of the base 402 and closes the cavity of the base 402, while the foldover flap 413 overlies and extends parallel to one of the side walls 408 of the base 402. A carrying handle 414 is affixed to the Holdover flap 413 and is located approximately equidistant from the bottom support surface 406 and the closure portion 411 of the cover 404. Convenient transport of the package 400 is therefore provided via the handle 414. The package 400 serves not only as a product package at a point of sale, but also as a reusable container to transport the footwear 410 after purchase, together or separate from other items of interest, whether food items or non-food items.

Like the foregoing packages, the base 402 and the cover 404 are fabricated from nylon, canvas, cloth, or other suitable materials to form a non-rigid or soft sided, yet structurally sufficient package relative to comparatively rigid cardboard and paper materials conventionally used in non-food product packaging (e.g., footwear packaging), and especially in comparison to known plastic and metallic materials conventionally used in hard-shell case construction. By employing nylon, canvas, cloth, or another non-rigid material to fabricate a soft shell package 400, a lightweight yet very durable package may be provided in a comparatively low cost construction.

A variety of materials may be employed to fabricated the package 400 to provide a distinctive appearance and to customize the package 400 for certain activities. For example, considering the example of FIG. 8, the cover 404 is fabricated from a substantially transparent material which permits ready visual inspection of the contents of the package 400 without opening the package 400. The package 400 is therefore well suited, for example, as packaging for boys footwear 410, and the package 400 may be reused, for example, as a carryall bag or brief case. Once the footwear 410 is removed, the package 400 may be packed with other items (food products or non-food products) to be stored, carried, or transported therein. Such items could be sold together with the non-food product (e.g., the footwear 410) in the package 400 or acquired separately by the consumer.

User friendly Velcro strips 412 is provided for ready access to the contents of the package 400 while avoiding bulky and difficult to use mechanical closure elements. It is understood, however, that the package may be otherwise adapted in various alternative embodiments, including the use of various known materials to fabricate the package, the use of other known closure members (e.g., zipper mechanisms, snaps, drawstrings, and other closure systems), the use of sealing elements to provide a sealed package, the use of insulated walls to allow the use of the package as a cooler, etc.

As with the foregoing packages, stiffening elements (not shown in FIG. 8), such as wire frame elements and the like, may be provided in the package 400 to maintain a desired shape of the cover 404, the base support surface 406, and/or the side walls 408 as desired or as necessary for added strength and rigidity of the package 400. Graphics and multiple colors may be employed on any of the outer surfaces of the package 400, and the shape of the package 400 may be varied to create distinctly different visual appearances of the package 400.

In an exemplary embodiment, the carrying handle 414 is fabricated from a nylon, canvas or other pliable material and are attached, for example, to the bottom support surface 406 according to a known method such as stitching. Like the rest of the package, the handle 414 may include stiffening frame elements to ensure a particular shape of the handle 414, and graphics and colors may be employed in the handle 414. The handle 414 may be fabricated into a variety of shapes in various embodiments to change the visual appearance of the package 400.

As described above, the package 400 may include indicia identifying a source of a non-food item, which may be the same as the non-food item sold in the package 400. Alternatively, such indicia could indicate the source of a food item which may be stored or transported in the package 400 at a later time. Indicia may include brand names, business names, trademarks, logos or other indicia to promote particular products or services, whether related or unrelated to either the non-food item sold in the package 300 or food-items which may be used therewith, including but not limited to indicia signifying a sports team, a cartoon character, an entertainment event, an entertainment figure or a movie. Thus, package themes and promotion of related and unrelated items and services may be graphically promoted on one or more of the outer surfaces of the package 400, including the top and bottom surfaces, and the side surfaces which connect the top and the bottom. Graphics and indicia may be transferred printed, or otherwise applied to the package in a known manner.

Each of the packages 200, 300, and 400 (FIGS. 6, 7, and 8, respectively) may be employed with similar methodology described above to promote innovative branding, selling and promotion for wide variety of products and services for mass appeal to different groups of consumers. Especially for products dominated by traditional cardboard packaging (e.g., footwear), the packages 200, 300 and 400 provide a welcome change, and the practicality of the packages reduces waste otherwise attributable to discarded product packaging.

While the invention has been described in terms of various specific embodiments, those skilled in the art will recognize that the invention can be practiced with modification within the spirit and scope of the claims.

1. A dual-use product package comprising:
a non-food product;
a non-rigid base defining a cavity holding said non-food product at a point of purchase display, said non-rigid base being adapted for use apart from said non-food product once the non-food product is removed from said cavity;
a cover configured to close said cavity, at least a portion of said cover being transparent; and
a carrying handle secured to one of said cover and said base and extending outwardly therefrom.

2. A product package in accordance with claim 1 further comprising a closure member securing said cover to said base.

3. A product package in accordance with claim 2 wherein said closure member comprises a zipper mechanism, said zipper mechanism spaced from a bottom surface of said base and spaced from said cover.

4. A product package in accordance with claim 2 wherein said carrying handle comprises a pair of handles, said closure member positioned between said pair of handles.

5. A product package in accordance with claim 1 wherein said cover comprises a front panel and a foldover flap, said package further comprising a closure member located on said foldover flap.

6. A product package in accordance with claim 1 wherein said non-food product constitutes footwear held in said cavity.

7. A product package in accordance with claim 1 further comprising at least one shoulder strap.

8. A product package in accordance with claim 1 wherein said base comprises a plurality of side walls, a portion of said side walls being transparent and a portion of said side walls being opaque.

9. A product package in accordance with claim 1 wherein at least one of said base and said cover is insulated wherein said package may function as a cooler.

10. A footwear package comprising:
a support surface;
a plurality of soft side walls extending from said support surface and defining a cavity for holding footwear above said support surface; and
a cover coupled to said base and secured thereto with a closure member extending on at least one said soft side walls, said cover being at least partially transparent for visual inspection of said cavity without opening said cover.

11. A footwear package in accordance with claim 10 further comprising a carrying handle.

12. A footwear package in accordance with claim 10 wherein said closure member comprises a zipper mechanism.

13. A footwear package in accordance with claim 12 further comprising a pair of carrying handles, said zipper mechanism extending between said pair of carrying handles.

14. A footwear package in accordance with claim 10 further comprising at least one shoulder strap.

15. A footwear package in accordance with claim 10 wherein said cover comprises a front panel and a foldover flap, said closure member coupled to said foldover flap.

16. A footwear package in accordance with claim 10 further comprising footwear in said cavity.

17. A footwear package in accordance with claim 10 wherein said cavity is packed with footwear at a point of purchase.

18. A footwear package in accordance with claim 10 wherein said cavity is packed with footwear at a first point in time and packed with food items at a second point in time.

19. A method of reusing a footwear package comprising;
packaging footwear in a soft sided package having the form of at least one of a backpack, a purse, and a brief case.

20. A method for selling a non-food item in combination with a dual-use container, said method comprising:
providing a dual-use container having a storage cavity;
packing a non-food item in the cavity;
closing the cavity with a cover;
presenting the dual-use container in combination with the non-food item packed therein at a point of purchase; and
configuring the dual use container to be reusable such that a purchaser of the dual use container in combination with the non-food item is able to remove the non-food item without damaging or destroying the dual-use container and repack the dual-use container for use as at least one of a backpack, a purse, and a brief case.

21. The method of claim 20 wherein the dual use container is formed with a non-rigid base.

22. The method of claim 20 wherein said packing includes closing a zipper connecting a cover and a base of the dual-use container.

23. The method of claim 20, wherein said non-food item constitutes at least one of clothing, footwear, a toy-related item, a sports-related item, a book, a magazine, a game-related item, an entertainment-related item, and an infant care-related item.

24. The method of claim 20 further comprising:
unpacking the cavity; and
repacking the cavity with a food item, wherein the food item constitutes one of an edible food item, a beverage, a beverage holder, utensils, plates, flatware, napkins, condiments, a food warmer and a cooling block.

25. The method of claim 20 further comprising providing indicia on the dual use container, said indicia identifying at least one of a source of a non-food item and a food item.

26. The method of claim 20, further comprising providing branding indicia on the dual use container identifying the source of a non-food item.

27. The method of claim 20, further comprising providing branding indicia on the dual use container identifying at least one of a sports team, a cartoon character, entertainment event, entertainment figure and movie, wherein said branding indicia is not indicative of a source of the non-food item.

28. The method of claim 20 further comprising providing at least one shoulder strap configured to carry said container.

29. A footwear package comprising:
a support surface;
a plurality of soft side walls extending from said support surface and defining a cavity for holding footwear above said support surface;
a cover coupled to said base and secured thereto with a closure member; and
at least one shoulder strap coupled to one of said support surface, said side walls, and said cover.

30. A footwear package in accordance with claim 29 wherein at least a portion of said cover is transparent.
